(19) United States
(12) Patent Application Publication
(10) Pub. No.: US 2013/0254595 A1
(43) Pub. Date: Sep. 26, 2013

(54) COMMUNICATION SYSTEM AND TEST APPARATUS

(71) Applicant: ADVANTEST CORPORATION, Tokyo (JP)

(72) Inventor: Kazumoto TAMURA, Gunma (JP)

(73) Assignee: ADVANTEST CORPORATION, Tokyo (JP)

(21) Appl. No.: 13/858,950

(22) Filed: Apr. 9, 2013

Related U.S. Application Data
(63) Continuation of application No. PCT/JP2011/002009, filed on Apr. 4, 2011.

(51) Int. Cl. G06F 11/263

(52) U.S. Cl. CPC G06F 11/263
USPC 714/35

(57) ABSTRACT

An instruction is assuredly transmitted. A test apparatus that tests a device under test, includes a test unit that tests a device under test by exchanging a signal with the device under test, a control apparatus that controls the test unit; and a relay apparatus that relays communication between the test unit and the control apparatus, where the control apparatus transmits an instruction to be given to the test unit a plurality of times to the test unit, and the test unit receives the instruction transmitted the plurality of times from the control apparatus, and executes the instruction once.

### BACKGROUND

1. Technical Field

The present invention relates to a communication system and a test apparatus.

2. Related Art

In a system including a control apparatus and a controlled apparatus, when the control apparatus has transmitted an instruction to the controlled apparatus via a serial communication line and the controlled apparatus has succeeded in receiving the instruction, the controlled apparatus will reply to the control apparatus with an acknowledgement. When failing to receive such an acknowledgement from the controlled apparatus within a certain period of time after the transmission of the instruction to the controlled apparatus, the control apparatus retransmits the corresponding instruction to the controlled apparatus. Such a system enables to ensure successful transmission of an instruction from a control apparatus to a controlled apparatus, and can reduce transmission errors of instructions.

However, a setback of such a system is that the control apparatus has to maintain the already transmitted instruction for a certain period of time. Therefore, the control apparatus has to have a buffer or the like, and so has to have a large dimension. In addition, such a system has required complex control to realize such retransmission of instructions.

### SUMMARY

Therefore, it is an object of an aspect of the innovations herein to provide a communication system and a test apparatus, which are capable of overcoming the above drawbacks accompanying the related art. The above and other objects can be achieved by combinations described in the claims. According to a first aspect of the present invention, provided is a communication system including a control apparatus and a controlled device, where the control apparatus transmits an instruction to be given to the controlled device a plurality of times to the controlled device, and the controlled device receives the instruction transmitted the plurality of times from the control apparatus, and executes the instruction once.

According to a second aspect of the present invention, provided is a test apparatus that tests a device under test, includes a test unit that tests a device under test by exchanging a signal with the device under test, a control apparatus that controls the test unit; and a relay apparatus that relays communication between the test unit and the control apparatus, where the control apparatus transmits an instruction to be given to the test unit a plurality of times to the test unit, and the test unit receives the instruction transmitted the plurality of times from the control apparatus, and executes the instruction once.

The summary clause does not necessarily describe all necessary features of the embodiments of the present invention. The present invention may also be a sub-combination of the features described above.

### BRIEF DESCRIPTION OF THE DRAWINGS

FIG. 1 shows a configuration of a test apparatus 10 according to the present embodiment.

FIG. 2 shows an exemplary processing flow of transmitting an instruction from a control apparatus 14 to a test unit 12 in normal times.

FIG. 3 shows an exemplary processing flow of transmitting an instruction from a control apparatus 14 to a test unit 12 in times when the buffer is congested.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

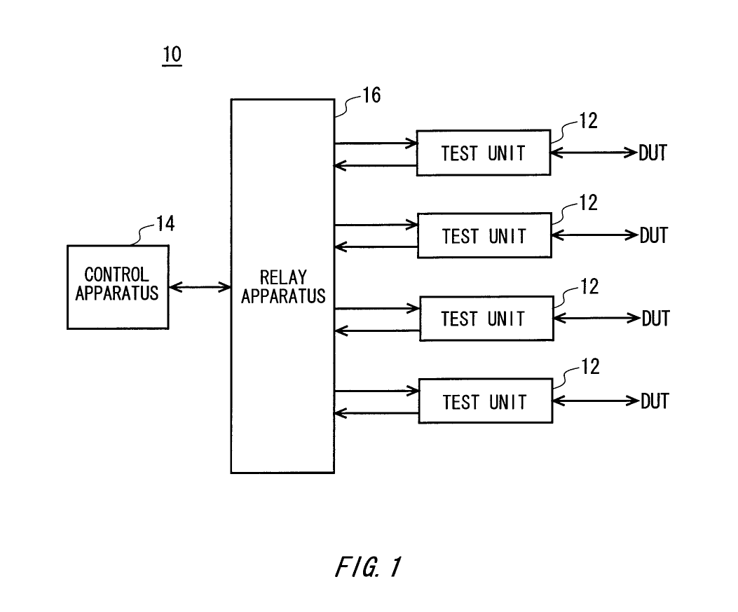

FIG. 1 shows a configuration of a test apparatus 10 according to the present embodiment. The test apparatus 10 tests a device under test (DUT) such as a semiconductor apparatus or the like. The test apparatus 10 includes one or more test units 12, a control apparatus 14, and a relay apparatus 16.

Each test unit 12 exchanges signals with a device under test. In an example, the test unit 12 supplies, to the device under test, a test signal having a waveform corresponding to a test pattern, and compares the response signal from the device under test with the logical value corresponding to the pattern of the expected value, thereby judging whether the device under test is good or bad.

The control apparatus 14 supplies an instruction to each of the one or more test units 12, to control the test unit 12. In other words, the control apparatus 14 controls each test unit 12 as a controlled apparatus. In an example, the control apparatus 14 is realized by a computer functioning as the control apparatus 14 by executing a program.

The relay apparatus 14 relays an instruction and a response between the control apparatus 14 and each of the one or more test units 12. The control apparatus 14 and the relay apparatus 16 are connected by Ethernet or the like. A serial signal is transmitted between the relay apparatus 16 and each test unit 12.

In the present embodiment, the serial signal transmitted between the relay apparatus 16 and each test unit 12 is compliant with a high-speed serial transmission standard called 8b/10b (or 10b/8b), but may be a signal in compliant with other standards such as USB3.0, PCIExpress or the like. A similar signal can also be transmitted between the control apparatus 14 and the relay apparatus 16.

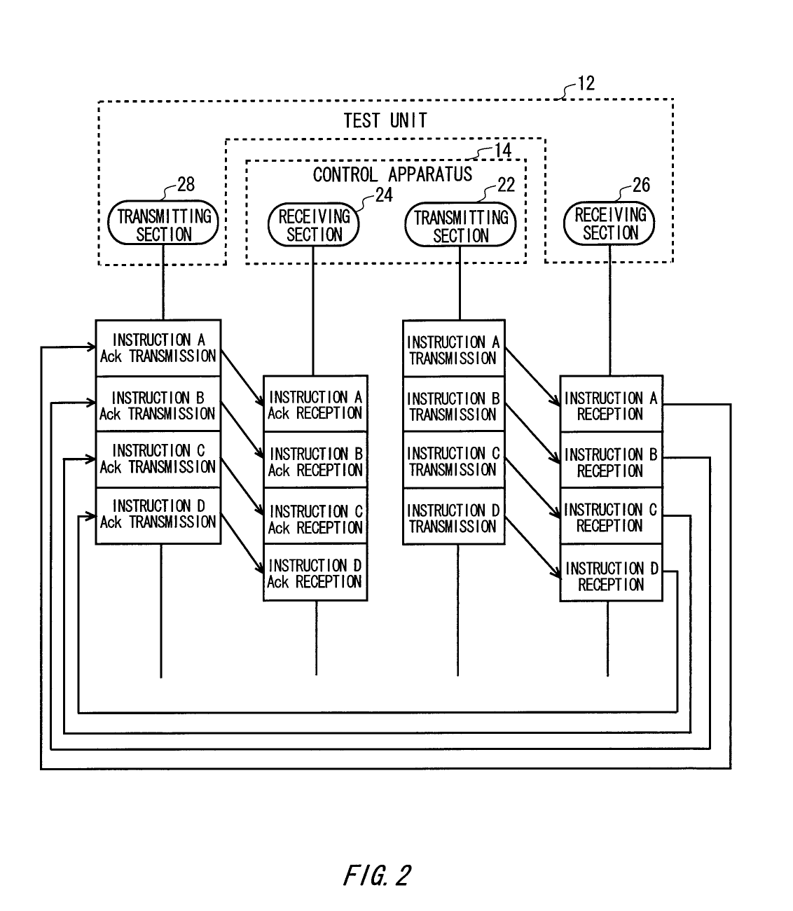

FIG. 2 shows a configuration of the control apparatus 14 and the test unit 12 as well as an exemplary processing flow of transmitting an instruction from the control apparatus 14 to any one of the test units 12 in normal times. The control apparatus 14 includes a transmitting section 22 that issues an instruction to the test unit 12, and a receiving section 24 that receives a response such as an acknowledgement from the test unit 12. In addition, each test unit 12 includes a receiving section 26 that receives an instruction from the control apparatus 14 and a transmitting section 28 that transmits a response such as an acknowledgement to the control apparatus 14.

The control apparatus 14 executes a program used for a test, and as a result of the execution of the program, transmits an instruction to each of the plurality of test units 12. The control apparatus 14 switches the instruction transmission method between when the number of instructions accumulated in the buffer provided on the path between the control apparatus 14 and the test unit 12 is a predetermined number or less (normal times) and when the number of instructions accumulated in the buffer exceeds the predetermined number (buffer congestion times).

When the number of instructions accumulated in the buffer provided on the path between the control apparatus 14 and the test unit 12 is a predetermined number or less, the control apparatus 14 and the test unit 12 executes the operation as shown in FIG. 2. The control apparatus 14 transmits an instruction to be given to the test unit 12 only once to the test unit 12. Upon reception of the instruction from the control apparatus 14, the test unit 12 executes the instruction once. In addition, upon reception of the instruction from the control apparatus 14, the test unit 12 transmits an acknowledgement indicating successful reception of the instruction, to the control apparatus 14.

When the control apparatus 14 has received an acknowledgement in response to the instruction that it has transmitted during a predetermined time period after the instruction has been transmitted, the control apparatus 14 completes the processing corresponding to the instruction judging that the instruction has been successfully received. On the other hand, when the control apparatus 14 has not received the acknowledgement in response to the instruction that it has transmitted during the predetermined time period after the instruction has been transmitted, the control apparatus 14 executes error processing. Specifically, the control apparatus 14 retransmits the instruction that it has transmitted, to the test unit 12. By executing such error processing, the control apparatus 14 and the test unit 12 can ensure successful transmission of an instruction from the control apparatus 14 to the test unit 12.

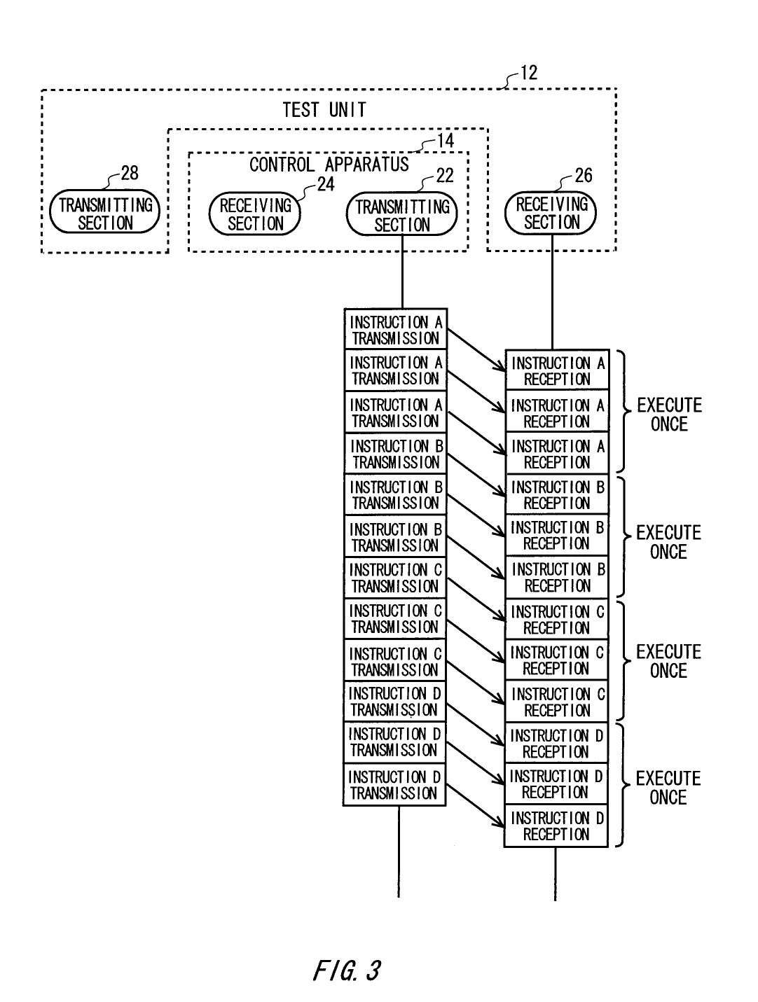

FIG. 3 shows an exemplary processing flow of transmitting an instruction from a control apparatus 14 to a test unit 12 in times when the buffer is congested (buffer congestion time). When the number of instructions accumulated in the buffer provided on the path between the control apparatus 14 and the test unit 12 exceeds the predetermined number, the control apparatus 14 and the test unit 12 execute the operation as shown in FIG. 3.

Specifically, the control apparatus 14 transmits an instruction to be given to the test unit 12 a plurality of times to the test unit 12. In an example, the control apparatus 14 transmits an instruction to be given to the test unit 12 a plurality of times sequentially to the test unit 12. It is alternatively possible that the control apparatus 14 transmit an instruction to be given to the test unit 12 a plurality of times by interleaving the instruction with another instruction.

In addition, the test unit 12 includes, in each instruction, the number of times of transmission by the control apparatus 14 of the instruction and the execution order of the instruction. For example, assume an example of transmitting, three times each, instructions A-D that are to be executed in the order of instruction A, instruction B, instruction C, and instruction D. In this example, the control apparatus 14 includes, in the instruction A, the execution order that the instruction A is to be executed Nthly (N being any positive integer), includes, in the instruction B, the execution order that the instruction B is to executed N+1thly, includes, in the instruction C, the execution order that the instruction C is to be executed N+2thly, and includes, in the instruction C, the execution order that the instruction D is to be executed N+3thly. Furthermore, the control apparatus 14 includes, in each of the instructions A-D, that it will be transmitted three times.

The test unit 12 receives the instruction transmitted a plurality of times from the control apparatus 14, and executes the instruction only once. In an example, the test unit 12 refers to the information on the execution order included in each instruction. When the instruction indicating the same execution order is received a plurality of times, the test unit 12 selects one of them, and aborts the remainder. Then, the test unit 12 executes the selected instructions in the order shown in the received execution orders.

In addition, the test unit 12 may adopt, for each bit, the rule of majority to the data sequences of the same instruction having been received a plurality of times in reconstructing the data sequence of the instruction. Then, the test unit 12 executes the instruction of the reconstructed data sequence in the order shown by the corresponding execution orders. By doing so, the test unit 12 can recover the error even when a part of the data sequence of the instruction caused an error, thereby enhancing the error resistance properties

Then, the test unit 12 does not send any acknowledgement to the control apparatus 14 even after completion of the instruction execution. In addition, when the number of instructions accumulated in the buffer provided on the path between the control apparatus 14 and the test unit 12 exceeds the predetermined number, the control apparatus 14 does not execute error processing when it fails to receive an acknowledgementment that indicates that the transmitted instruction has been successfully received.

The control apparatus 14 and the test unit 12 having the stated construction can ensure transmission of an instruction from the control apparatus 14 to the test unit 12, even when the buffer provided in the control apparatus 14 and the test unit 12 is congested and so any attempt of confirmation using the acknowledgement may result in timeout. Accordingly, the test apparatus 10 according to the present embodiment can ensure successful transmission of an instruction from the control apparatus 14 to the test unit 12 by a simple configuration and simple control.

Note that when the number of instructions accumulated in the buffer provided on the path between the control apparatus 14 and the test unit 12 exceeds a predetermined number, the control apparatus 14 transmits a read instruction to the test unit 12 a plurality of times. When failing to receive any response to the read instruction within a predetermined time period, the control apparatus 14 can judge that there occurred an error on the path between it and the test unit 12. By this configuration, the control apparatus 14 can judge occurrence of a transmission error even when the test unit 12 does not transmit an acknowledgement to the control apparatus 14.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A test apparatus that tests a device under test, comprising:
a test unit that tests the device under test by exchanging a signal with the device under test;
a control apparatus that controls the test unit; and
a relay apparatus that relays communication between the test unit and the control apparatus, wherein
the control apparatus transmits an instruction to be given to the test unit a plurality of times to the test unit, and
the test unit receives the instruction transmitted the plurality of times from the control apparatus, and executes the instruction once.

2. The test apparatus according to claim 1, wherein
the control apparatus includes, in each instruction, an execution order of the instruction in the test unit and the number of times the instruction is to be transmitted by the control apparatus.

3. The test apparatus according to claim 2, wherein
when the number of instructions accumulated in a buffer provided on a path between the control apparatus and the test unit is a predetermined number or less, the control apparatus transmits an instruction to be given to the test unit only once to the test unit, and executes error processing when failing to receive any acknowledgement in response to the transmitted instruction, and
when the number of instructions accumulated in the buffer provided on the path between the control apparatus and the test unit exceeds the predetermined number, the control apparatus transmits the instruction to be given to the test unit a plurality of times to the test unit, and does not execute error processing when failing to receive an acknowledgement indicating that the transmitted instruction has been received.

4. The test apparatus according to claim 1, wherein
the control apparatus transmits a read instruction a plurality of times to the test unit, and when failing to receive a response to the read instruction within a predetermined time has passed, judges that an error has occurred on a path between the control apparatus and the test unit.
